(19) United States
(12) Patent Application Publication
(10) Pub. No.: US 2026/0101875 A1
(43) Pub. Date: Apr. 16, 2026

(54) PET SAFETY COLLAR DEVICE

(71) Applicant: Darryl Kimble, Hawthorne, CA (US)

(72) Inventor: Darryl Kimble, Hawthorne, CA (US)

(21) Appl. No.: 18/917,572

(22) Filed: Oct. 16, 2024

(51) Int. Cl. A01K 27/00; A01K 11/00; A01K 29/00

(52) U.S. Cl. CPC A01K 27/006; A01K 11/008; A01K 27/001; A01K 29/005

(57) ABSTRACT

A pet safety collar device for monitoring, locating, and increasing visibility of a pet includes a strap having first and second ends and inner and outer surfaces along with a housing having first and second side faces and an outer face to which light emitting diodes (LEDs) are attached. The first side face is attached to the first end of the strap. First and second locking elements, which are attached to the housing and to the second end, respectively, can secure the strap around a neck of the pet. A microprocessor in the housing is operationally engaged to the plurality of light emitting diodes, a battery, the first locking element, and a communications transceiver, which can exchange signals with an electronic device of a user. The microprocessor is programmed to selectively actuate the first locking element and the LEDs upon receipt of signals from the electronic device of the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet safety devices and more particularly pertains to a new pet safety device for monitoring, locating, and increasing visibility of a pet. Pets, such as small dogs and cats, can be stepped upon at home, particularly at night. Having the pet fitted with an illuminated collar would help to prevent this. Additionally, being able to monitor the pet when separated would be of benefit, as would being able to locate the pet if it is lost or stolen.

### (2) Description of Related Art Including Information Disclosed Under 37 CFR 1.97 and 1.98

The prior art relates to pet safety devices having one or more of remote locking/unlocking, lighting, tracking, and locating elements. Related prior art includes strobe lights configured to be attachable to collars, leashes with integral lights. What is lacking in the prior art is a collar that can be selectively illuminated to increase visibility of the pet, which is fitted with a camera for monitoring the pet and its surroundings, and which can be used to locate the pet if lost or stolen.

### BRIEF SUMMARY OF THE INVENTION

An embodiment of the disclosure meets the needs presented above by generally comprising a strap, which has a first end, a second end, an inner surface, and an outer surface, and a housing, which has a first side face, a second side face, and an outer face. The housing defines an interior space and the first side face is attached to the first end of the strap. A plurality of light emitting diodes is attached to the outer surface of the strap. A first locking element is attached to the housing and positioned in the interior space adjacent to the second side face. A second locking element is attached to second end of the strap. The second locking element is complementary to the first locking element so that the first locking element is enabled to selectively engaging the second locking element,. The first locking element and the second locking element are configured to selectively securing the strap in a closed configuration around a neck of a pet. A battery, a communications transceiver, and a microprocessor are attached to the housing and are positioned in the interior space. The microprocessor is operationally engaged to the plurality of light emitting diodes, the battery, the first locking element, and the communications transceiver. The communications transceiver is configured for exchange of signals with an electronic device of a user. The microprocessor is programmed to selectively actuate the first locking element and the plurality of light emitting diodes upon receipt of corresponding signals from the electronic device of the user via the communications transceiver.

Another embodiment of the disclosure includes a pet safety collar system, which comprises a pet safety collar device, as per the disclosure above, and an electronic device. The electronic device is configured to accept programming code, which enables the electronic device to signal the microprocessor, via the communications transceiver, to selectively actuate the first locking element to secure the strap in the closed configuration and to power the plurality of light emitting diodes.

Most typically, the pet safety collar device of the pet safety collar system will comprise a video camera and a locating transceiver. The video camera is attached to the outer face of the housing while the locating transceiver is attached to the housing and positioned in the interior space. Both are operationally engaged to the microprocessor. The video camera is configured to capture a video image of an area proximate to the housing, thereby enabling the microprocessor to communicate the video image to the electronic device of the user via the communications transceiver. The locating transceiver is Global Positioning System (GPS) enabled and thus is configured to receive location coordinates of the housing. The microprocessor to communicate a location of the housing to the electronic device of the user via the communications transceiver.

Yet another embodiment of the disclosure includes a method of enhancing safety for a pet. The method comprises a first step providing the pet safety collar system, as per the specification above and including the video camera and the locating transceiver. A second step of the method is positioning the strap around the neck of the pet. A third step of the method is using the electronic device to signal the microprocessor to actuate the first locking element for selectively engaging the second locking element for securing the strap in the closed configuration around the neck of the pet. A fourth step of the method is using the electronic device to signal the microprocessor to actuate the plurality of light emitting diodes. A fifth step of the method is wandering of the pet away from the user. A sixth step of the method is using the electronic device to receive the video image of the area proximate to the housing. A seventh step of the method is using the electronic device to receive the location of the housing and thus the pet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a pet safety collar device according to an embodiment of the disclosure.

FIG. 2 is a top view of an embodiment of the disclosure.

FIG. 3 is a cross-sectional view of an embodiment of the disclosure.

FIG. 4 is a detail view of an embodiment of the disclosure.

FIG. 5 is an in-use view of an embodiment of the disclosure.

FIG. 6 is a block diagram of an embodiment of the disclosure.

FIG. 7 is a flow diagram for a method utilizing an embodiment of the disclosure.

### DETAILED DESCRIPTION OF THE INVENTION

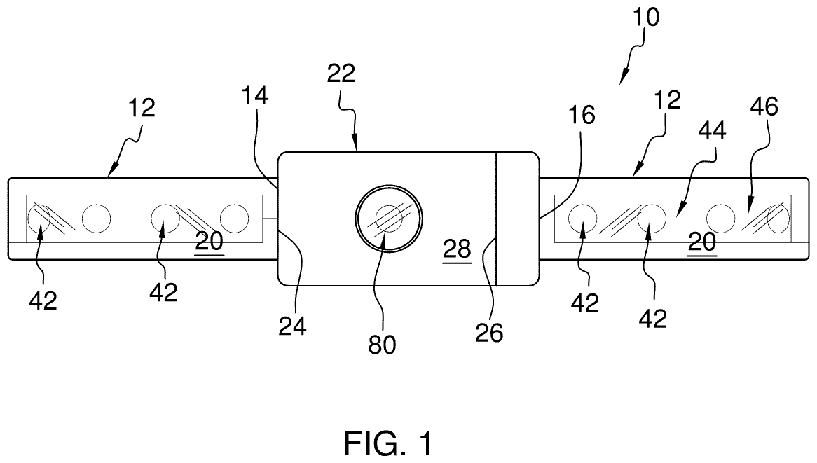

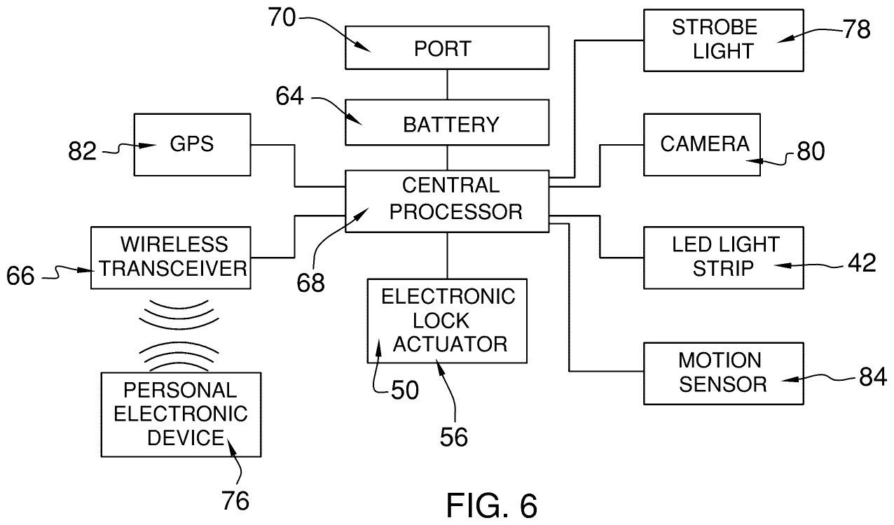

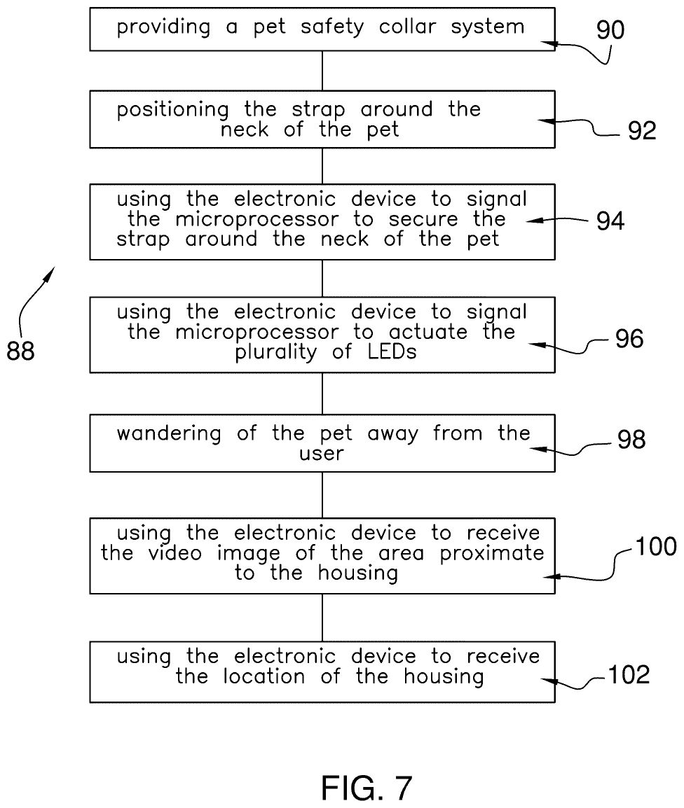

With reference now to the drawings, and in particular to FIGS. 1 through 7 thereof, a new pet safety device embodying the principles and concepts of an embodiment of the disclosure and generally designated by the reference numeral 10 will be described.

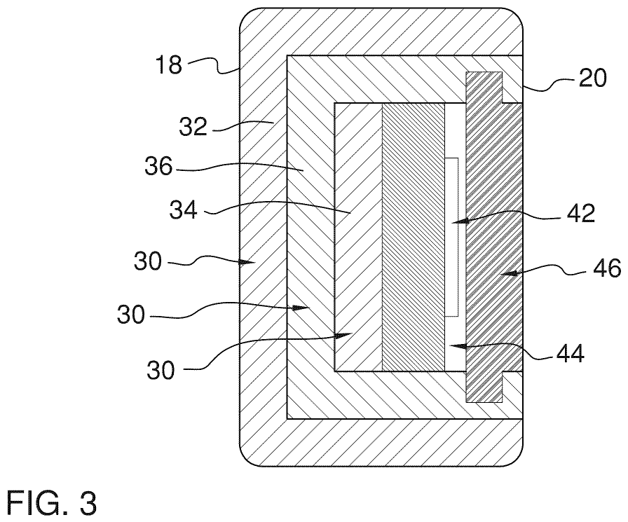

As best illustrated in FIGS. 1 through 7, the pet safety collar device 10 generally comprises a strap 12, which has a first end 14, a second end 16, an inner surface 18, and an outer surface 20, and a housing 22, which has a first side face 24, a second side face 26, and an outer face 28. Typically, the strap 12 comprises a plurality of layers 30 with each layer 30 comprising poly-paraphenylene terephthalamide. The strap 12 is configured to resist being severed by a cutting tool. The plurality of layers 30 may comprise an outer layer 32, an inner layer 34, and a medial layer 36, which is attached to and sandwiched between the outer layer 32 and the inner layer 34, as is shown in FIG. 3. The present invention also anticipates the strap 12 comprising other materials that are resistant to being cut, such as, but not limited to, steel, titanium, or the like.

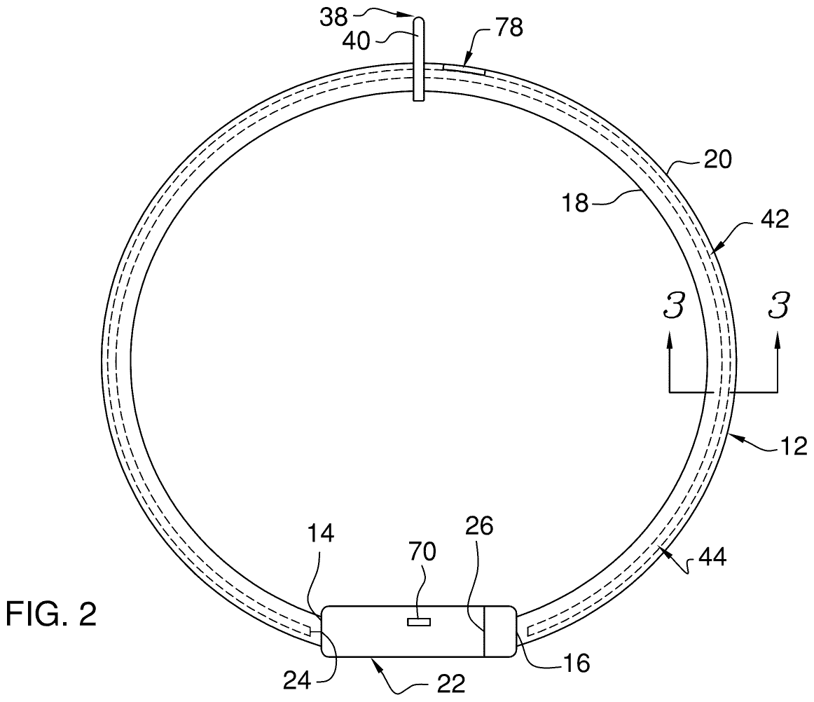

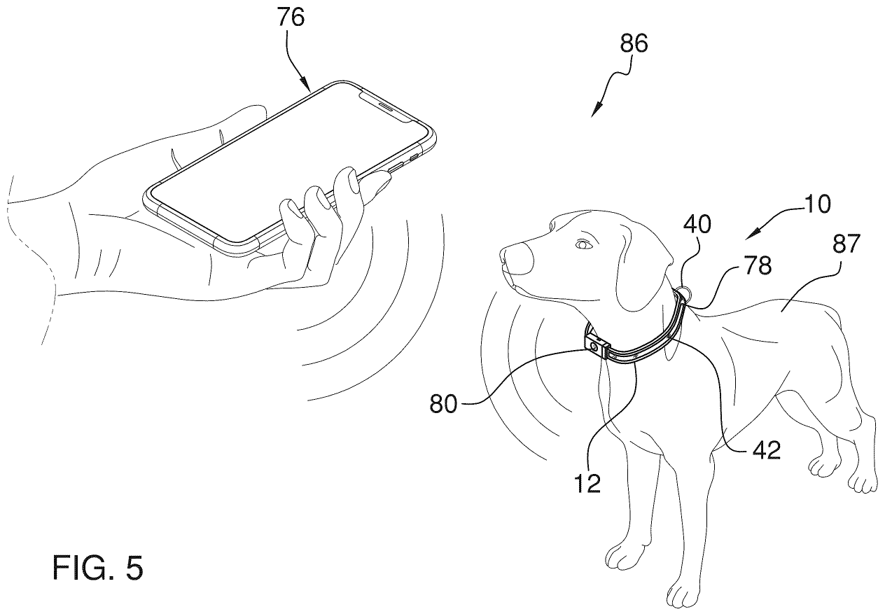

A connector 38 may be attached to the strap 12 and be configured to be complementary to a coupler of a leash, thereby allowing the connector 38 to selectively attaching the strap 12 to the leash. This would be useful for pets that are walked, in particular dogs but sometimes including cats. The coupler may comprise a D-ring 40, as is shown in FIGS. 2 and 5. “Pet” in the context of this disclosure is not meant to be limiting, such as to typical household pets such as dogs and cats. Rather, “pet” in the context of this disclosure also can include livestock, such as cows, horses, llamas, sheep, pigs, or the like. It is anticipated that users will find other applications for the pet safety collar device 10 and the pet safety collar system 86, which is discussed below.

A plurality of light emitting diodes 42 is attached to the outer surface 20 of the strap 12. As is shown in FIG. 3, a cutout 44 is positioned in the outer surface 20 of the strap 12 and extends from proximate to the first end 14 to proximate to the second end 16 of the strap 12 with the plurality of light emitting diodes 42 being attached to the strap 12 within the cutout 44. A strip 46 is attached to the strap 12 and covers the cutout 44. The strip 46 is substantially transparent so that light from the light emitting diodes 42 passes through the strip 46.

The housing 22 defines an interior space 48 and the first side face 24 is attached to the first end 14 of the strap 12. A first locking element 50 is attached to the housing 22 and is positioned in the interior space 48 adjacent to the second side face 26. A second locking element 52 is attached to second end 16 of the strap 12. The second locking element 52 is complementary to the first locking element 50 so that the first locking element 50 is enabled to selectively engage the second locking element 52. The first locking element 50 and the second locking element 52 thus are configured to selectively secure the strap 12 in a closed configuration around a neck of a pet, as is shown in FIG. 5.

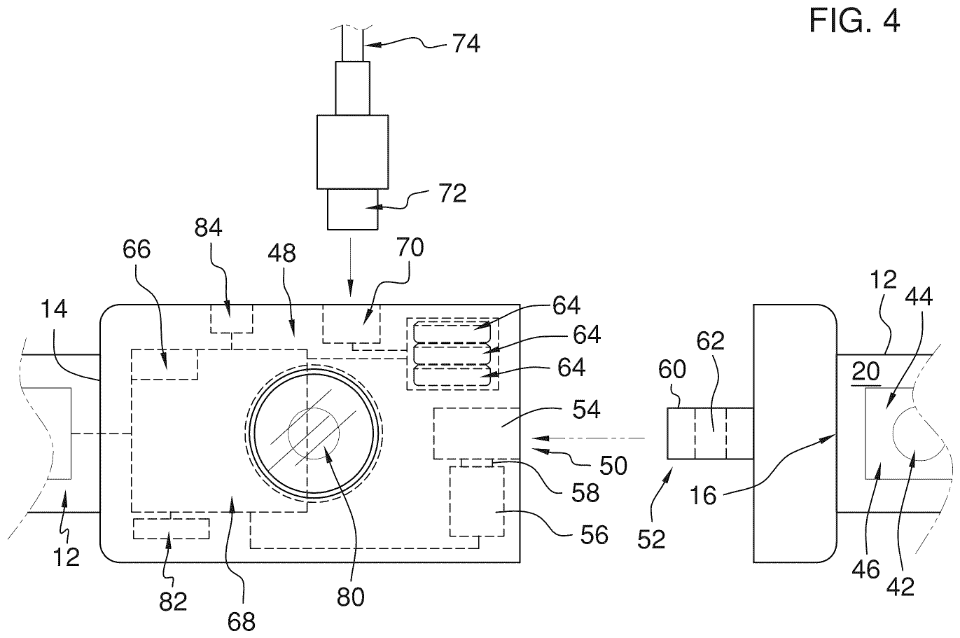

As is shown in FIG. 4, the first locking element 50 comprises a void 54, which extends into the second side face 26 of the housing 22, and an actuator 56, which comprises a piston 58. The piston 58 is selectively extensible from the actuator 56 into the void 54. The second locking element 52 comprises a cylinder 60, which is attached to and which extends from the second end 16 of the strap 12. The cylinder 60 is complementary to the void 54 so that the cylinder 60 is selectively insertable into the void 54. A channel 62 extends through the cylinder 60 and is positioned for selective insertion of the piston 58 to secure the strap 12 in the closed configuration. It will be apparent to those skilled in the art of remotely actuatable locks that other locking means can be used, such as, but not limited to, magnetic locks, cam locks, or the like, to secure the strap 12 in the closed configuration.

A battery 64, a communications transceiver 66, and a microprocessor 68 are attached to the housing 22 and are positioned in the interior space 48. As is shown in FIGS. 2 and 4, a port 70 is positioned in the housing 22 and is operationally engaged to the battery 64. The port 70 enables insertion of a complementary plug 72 of a charging cord 74 to recharge the battery 64. The microprocessor 68 is operationally engaged to the plurality of light emitting diodes 42, the battery 64, the first locking element 50, and the communications transceiver 66. The communications transceiver 66 is configured for exchange of signals with an electronic device 76 of a user. The microprocessor 68 is programmed to selectively actuate the first locking element 50 and the plurality of light emitting diodes 42 upon receipt of corresponding signals from the electronic device 76 of the user via the communications transceiver 66.

The microprocessor 68 also may be programmed to selectively and alternately power one or more of the light emitting diodes 42 to create a strobing effect upon receipt of a corresponding signal from the electronic device 76 of the user via the communications transceiver 66. Alternatively, a strobe light 78 may be attached to the outer surface 20 of the strap 12 and operationally engaged to the microprocessor 68. The microprocessor 68 then would be programmed to selectively power the strobe light 78 upon receipt of a corresponding signal from the electronic device 76 of the user via the communications transceiver 66.

As is shown in FIGS. 1 and 4, a video camera 80 is attached to the outer face 28 of the housing 22 and is operationally engaged to the microprocessor 68. The video camera 80 is configured to capture a video image of an area proximate to the housing 22, thereby enabling the microprocessor 68 to communicate the video image to the electronic device 76 of the user via the communications transceiver 66. The user thus can monitor what is happening near the pet.

A locating transceiver 82 is attached to the housing 22, positioned in the interior space 48, and operationally engaged to the microprocessor 68. The locating transceiver 82 is Global Positioning System (GPS) enabled and thus is configured to receive location coordinates of the housing 22. The microprocessor 68 then can communicate a location of the housing 22, and thus the pet, to the electronic device 76 of the user via the communications transceiver 66. It also is anticipated that the communications transceiver 66 can access nearby cellular tower(s) to obtain an approximate location for the housing 22 and then communicate the approximate location to the electronic device 76.

A motion sensor 84 is attached to the housing 22, positioned in the interior space 48, and operationally engaged to the microprocessor 68. The motion sensor 84 is configured to detect motion of the housing 22, and thereby the pet. The microprocessor 68 enables the microprocessor 68 to communicate a movement event of the housing 22 to the electronic device 76 of the user via the communications transceiver 66. The microprocessor 68 may be programmed to actuate the video camera 80 upon detection of a movement event by the motion sensor 84.

The present invention also anticipates a pet safety collar system 86, which comprises a pet safety collar device 10, as per the specification above, and an electronic device 76, as is shown in FIG. 5. The electronic device 76 is configured to accept programming code, which enables the electronic device 76 to signal the microprocessor 68, via the communications transceiver 66, to selectively actuate the first locking element 50 to secure the strap 12 in the closed configuration and to power the plurality of light emitting diodes 42.

Most typically, the pet safety collar device 10 of the pet safety collar system 86 will comprise a video camera 80 and a locating transceiver 82. The video camera 80 is attached to the outer face 28 of the housing 22 while the locating transceiver 82 is attached to the housing 22 and positioned in the interior space 48. Both are operationally engaged to the microprocessor 68. The video camera 80 is configured to capture a video image of an area proximate to the housing 22, thereby enabling the microprocessor 68 to communicate the video image to the electronic device 76 of the user via the communications transceiver 66. The locating transceiver 82 is Global Positioning System (GPS) enabled and thus is configured to receive location coordinates of the housing 22. The microprocessor 68 thus can communicate a location of the housing 22 to the electronic device 76 of the user via the communications transceiver 66.

Additionally anticipated is the pet safety collar system 86 being part of a networked system allowing the user to post one or more pictures of the pet, video images of the location proximate to the pet, and other details regarding the pet, contact information, potential reward, and the like, to a website in event the pet is lost or stolen. This information also may be transmitted to an appropriate law enforcement agency.

The pet safety collar system 86 enables a method of enhancing safety for a pet 88. The method 88 comprises a first step 90 providing a pet safety collar system 86, as per the specification above. The pet safety collar device 10 of the pet safety collar system 86 used in this method 88 also includes a video camera 80 to capture a video image of an area proximate to the housing 22, and a locating transceiver 82 to receive location coordinates of the housing 22. A second step 92 of the method 88 is positioning the strap 12 around the neck of the pet. A third step 94 of the method 88 is using the electronic device 76 to signal the microprocessor 68 to actuate the first locking element 50 to selectively engage the second locking element 52 to secure the strap 12 in the closed configuration around the neck of the pet. A fourth step 96 of the method 88 is using the electronic device 76 to signal the microprocessor 68 to actuate the plurality of light emitting diodes 42. A fifth step 98 of the method 88 is wandering of the pet away from the user. A sixth step 100 of the method 88 is using the electronic device 76 to receive the video image of the area proximate to the housing 22. A seventh step 102 of the method 88 is using the electronic device 76 to receive the location of the housing 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pet safety collar device comprising:
a strap having a first end, a second end, an inner surface, and an outer surface;
a plurality of light emitting diodes being attached to the outer surface of the strap;
a housing having a first side face, a second side face, and an outer face, the housing defining an interior space, the first side face of the housing being attached to the first end of the strap;
a first locking element being attached to the housing and positioned in the interior space adjacent to the second side face;
a second locking element being attached to the second end of the strap, the second locking element being complementary to the first locking element such that the first locking element is enabled for selectively engaging the second locking element, wherein the first locking element and the second locking element are configured for selectively securing the strap in a closed configuration around a neck of a pet;
a battery being attached to the housing and positioned in the interior space;
a communications transceiver being attached to the housing and positioned in the interior space, wherein the communications transceiver is configured for exchange of signals with an electronic device of a user; [and] a microprocessor being attached to the housing and positioned in the interior space, the microprocessor being operationally engaged to the plurality of light emitting diodes, the battery, the first locking element, and the communications transceiver, the microprocessor being programmed for selectively actuating the first locking element and the plurality of light emitting diodes upon receipt of corresponding signals from the electronic device of the user via the communications transceiver; and
a cutout being positioned in the outer surface of the strap and extending from proximate to the first end to proximate to the second end of the strap, the plurality of light emitting diodes being attached to the strap within the cutout.

2. The pet safety collar device of claim 1, wherein:
the first locking element comprises:
a void extending into the second side face of the housing; and
an actuator comprising a piston, the piston being selectively extensible from the actuator into the void; and
the second locking element comprises:
a cylinder being attached to and extending from the second end of the strap, the cylinder being complementary to the void such that the cylinder is selectively insertable into the void; and
a channel extending through the cylinder and being positioned for selective insertion of the piston for securing the strap in the closed configuration.

3. (canceled)

4. The pet safety collar device of claim 1, further comprising a strip being attached to the strap and covering the cutout, the strip being substantially transparent such that light from the light emitting diodes passes through the strip.

5. The pet safety collar device of claim 1, wherein the microprocessor is programmed to selectively and alternately power one or more of the light emitting diodes of the plurality of light emitting diodes for creating a strobing effect upon receipt of a corresponding signal from the electronic device of the user via the communications transceiver.

6. The pet safety collar device of claim 1, further comprising a strobe light being attached to the outer surface of the strap and operationally engaged to the microprocessor, the microprocessor being programmed to selectively power the strobe light upon receipt of a corresponding signal from the electronic device of the user via the communications transceiver.

7. The pet safety collar device of claim 1, further comprising a video camera being attached to the outer face of the housing and operationally engaged to the microprocessor, wherein the video camera is configured for capturing a video image of an area proximate to the housing, thereby enabling the microprocessor for communicating the video image to the electronic device of the user via the communications transceiver.

8. The pet safety collar device of claim 1, further comprising a locating transceiver being attached to the housing, positioned in the interior space, and operationally engaged to the microprocessor, the locating transceiver being Global Positioning System (GPS) enabled, wherein the locating transceiver is configured for receiving location coordinates of the housing, thereby enabling the microprocessor for communicating a location of the housing to the electronic device of the user via the communications transceiver.

9. The pet safety collar device of claim 1, further comprising a motion sensor being attached to the housing, positioned in the interior space, and operationally engaged to the microprocessor, wherein the motion sensor is configured for detecting motion of the housing, thereby enabling the microprocessor for communicating a movement event of the housing to the electronic device of the user via the communications transceiver.

10. The pet safety collar device of claim 1, wherein the strap comprises a plurality of layers, each layer comprising poly-paraphenylene terephthalamide, wherein the strap is configured for resisting being severed by a cutting tool.

11. The pet safety collar device of claim 10, wherein the plurality of layers comprises an outer layer, an inner layer, and a medial layer being attached to and sandwiched between the outer layer and the inner layer.

12. The pet safety collar device of claim 1, further comprising a connector being attached to the strap, the connector being configured to be complementary to a coupler of a leash, wherein the connector is configured for selectively attaching the strap to the leash.

13. The pet safety collar device of claim 1, further comprising:
the first locking element comprising:
a void extending into the second side face of the housing; and
an actuator comprising a piston, the piston being selectively extensible from the actuator into the void; and
the second locking element comprising:
a cylinder being attached to and extending from the second end of the strap, the cylinder being complementary to the void such that the cylinder is selectively insertable into the void; and
a channel extending through the cylinder and being positioned for selective insertion of the piston for securing the strap in the closed configuration;
a strip being attached to the strap and covering the cutout, the strip being substantially transparent such that light from the light emitting diodes passes through the strip;
the microprocessor being programmed to selectively and alternately power one or more of the light emitting diodes of the plurality of light emitting diodes for creating a strobing effect upon receipt of a corresponding signal from the electronic device of the user via the communications transceiver;
a strobe light being attached to the outer surface of the strap and operationally engaged to the microprocessor, the microprocessor being programmed to selectively power the strobe light upon receipt of a corresponding signal from the electronic device of the user via the communications transceiver;
a video camera being attached to the outer face of the housing and operationally engaged to the microprocessor, wherein the video camera is configured for capturing a video image of an area proximate to the housing, thereby enabling the microprocessor for communicating the video image to the electronic device of the user via the communications transceiver;
a locating transceiver being attached to the housing, positioned in the interior space, and operationally engaged to the microprocessor, the locating transceiver being Global Positioning System (GPS) enabled, wherein the locating transceiver is configured for receiving location coordinates of the housing, thereby enabling the microprocessor for communicating a location of the housing to the electronic device of the user via the communications transceiver;
a motion sensor being attached to the housing, positioned in the interior space, and operationally engaged to the microprocessor, wherein the motion sensor is configured for detecting motion of the housing, thereby enabling the microprocessor for communicating a movement event of the housing to the electronic device of the user via the communications transceiver;
the strap comprising a plurality of layers, each layer comprising poly-paraphenylene terephthalamide, wherein the strap is configured for resisting being severed by a cutting tool;
the plurality of layers comprising an outer layer, an inner layer, and a medial layer being attached to and sandwiched between the outer layer and the inner layer; and
a connector being attached to the strap, the connector being configured to be complementary to a coupler of a leash, wherein the connector is configured for selectively attaching the strap to the leash.

14. (canceled)

15. (canceled)

16. (canceled)

17. (canceled)
